(19) United States
(12) Patent Application Publication
(10) Pub. No.: US 2015/0052232 A1
(43) Pub. Date: Feb. 19, 2015

(54) RELIABILITY OF MULTI-STATE INFORMATION NETWORK EVALUATION METHOD AND SYSTEM THEREOF

(71) Applicant: NATIONAL TSING HUA UNIVERSITY, HSINCHU (TW)

(72) Inventors: WEI-CHANG YEH, Hsinchu City (TW); YUAN-MING YEH, Hsinchu City (TW)

(73) Assignee: NATIONAL TSING HUA UNIVERSITY, HSINCHU (TW)

(21) Appl. No.: 14/194,241

(22) Filed: Feb. 28, 2014

(30) Foreign Application Priority Data
Aug. 13, 2013 (TW) 102129063

(51) Int. Cl. H04L 12/24

(52) U.S. Cl. CPC H04L 41/046
USPC 709/223

(57) ABSTRACT

A reliability of multi-state information network evaluation method and system thereof are disclosed in the present invention. The system comprises a storage unit, a universal generation function process unit, a reliability calculating unit, and a judging unit. The feature of the invention is to develop a novel method for evaluation of the reliability based on the disconnectedness between nodes and targets. Therefore, a decision-maker can analyze the network according to the invention and apply the analysis result in lots of applications, such as computer communication system, electronic transmission system, transportation system, etc.

### CROSS-REFERENCE TO RELATED APPLICATION

This application claims priority from Taiwan Patent Application No. 102129063, filed on Aug. 13, 2013 in Taiwan Intellectual Property Office, the contents of which are hereby incorporated by reference in their entirety.

### BACKGROUND OF THE INVENTION

1. Field of the Invention

The present invention is related to a network reliability evaluation system and method thereof, and particularly is related to an system capable of evaluating the reliability for a multi-state information network and method thereof.

2. Description of the Related Art

The network reliability theory is used broadly in many systems in the real world, such as communication systems, transportation systems, petroleum/gas transportation pipeline systems, computer network systems, and mobile-phone network systems. The network reliability plays an important role in the real world.

A multi-state information network is a popular network mechanism. The multi-state information network has a starting node and whole information is transmitted from the starting node. A plurality of nodes are responsible for transmitting the information via a plurality of arcs in the multi-state information network. Finally, the information is transmitted to different target nodes. Above process of information transmission follows the flow conservation. Evaluating the probability of connecting the starting node to the plurality of target nodes is defined as the reliability evaluation of the multi-state information network.

Generally, the reliability of the multi-state information network is evaluated via a universal generation function, a recursive technique and a simplify technique. However, when the status of the network is closed to a complete graph, the heavy complexity will be incurred if the universal generation function is employed. Therefore, based on a novel disconnectedness feature between the starting node and target nodes, a universal generation function for evaluating the reliability and the non-reliability for the multi-state information network is proposed by the present inventor. In other words, the reliability evaluation is accomplished by the manners of combination, replacement, and transformation. So the features of the novelty and the non-obviousness are available in the present invention.

### SUMMARY OF THE INVENTION

The embodiment of the present invention is directed to a system capable of evaluating the reliability of the multi-state information. network. The system bases the disconnectedness feature to calculate the reliability and non-reliability of the multi-state network so as to speed up the reliability evaluation of the multi-state information network. Furthermore, the novel evaluation method can be supplied to industries as well.

The present invention provides a reliability of a multi-state information network evaluation method which is applicable to a network. The network comprises a plurality of nodes and a plurality of arcs to connect the plurality of nodes, and the plurality of nodes at least comprises a starting node and a target node. The evaluation method comprises the following steps. a. A counting value (i) is set as 2 and the starting node is set as [1] to calculate u([1]) and U([1]) by a universal generation function process unit. The first-stage node is represented by [1], the universal generation function of the first-stage node is represented by u([1]), the universal generation function of the first-stage sub-network is represented by U([1]), and U([1])=u([1]). b. A node v is set as [i] by the universal generation function. process unit and u([i]) is calculated by [i]. The i-stage node is represented by [i], the i-stage node universal generation function is represented by u([i]), the node v is connected to V_{[i-1]} and the node v does not belong to V_{[i-1]}, and V_{[i-1]}={[1], [2], . . . [i−1]}. c. U([i−1]) and u([i]) are applied to the universal generation function process unit to calculate and simplify U([i]), and the i−1 stage and the i stage universal generation functions are represented by U([k−1]) and U([i]), respectively. d. A reliability coefficient R_{J} is obtained by applying U([i]) and a set J to a reliability calculating unit, and the reliability coefficient R_{J} is applied to perform a calculation of a network reliability. The set is contained in a set including at least a target node, and the reliability coefficient R_{J} is the probability of all target nodes not in J receiving information from the starting node in U([i]). e. A judging unit is used to judge if the counting value (i) is less than a threshold value, and the counting value is incremented by 1 and step b is performed if the counting value (i) is less than the threshold value.

Preferably, the threshold value is equal to the number of nodes of the plurality of nodes excluding at least one of the target nodes.

Preferably, u([i])=Σ_{I∈θj} p_{i:I}Z^{I}, Θᵢ is a set of nodes which can be reached from [i], p_{i:I}Z^{I} is a total probability of starting from [i] to reach nodes of the set I.

Preferably, R_{J}=Σ_{I}π_{i:I}, π_{i:I} is a probability of starting from [i] and unable to reach any node of the set I via a sub-network of the network.

Preferably, the universal generation function process unit comprises a multiplication operator [symbol] to apply to the calculation of the universal generation function.

A reliability of a multi-state information network evaluation system is applicable to a network. The network comprises a plurality of nodes and a plurality of arcs to connect the plurality of nodes, and the plurality of nodes at least comprises a starting node and a target node. The evaluation system comprises: a storage unit, adapted to save a counting value (i) and a network status of the network, wherein the counting value (1) is set as 1 initially; a universal generation function process unit, adapted to calculate u([i]) and U([i]) via applying the network status, the counting value (i), a node v, and U([i −1]), and simplify U(i) before storing U(i) into the storage unit, wherein i is a positive integer, [i] represents the i-stage node, U(i) represents universal generation function of the i-stage sub-network, and u([i]) represents universal generation function of the i-stage node; a reliability calculating unit, adapted to obtain a reliability coefficient R_{J} via applying the network status, U(i) and a set J, and apply the coefficient R_{J} to perform a calculation of a network reliability, wherein the set J is contained in a set including at least a target node, and the reliability coefficient R_{J} is the probability of all target nodes not in J receiving information from the starting node in U([i]); and a judging unit, adapted to judge if the counting value (i) is less than a threshold value, the counting value (i) being incremented by 1, the universal generation function process unit is enabled to continue the process, and the reliability calculating unit is enabled to continue the calculation; wherein the node v is the starting node if the counting value (i) is equal to 1; the node v is connected to V[i−1] and v is not belong to any node of V[i−1] if the counting value (i) is not equal to 1.

Preferably, the threshold value is equal to the number of nodes of the plurality of nodes excluding at least one of the target nodes.

Preferably, u([i])=Σ_{I∈θ}_{ᵢ} p_{i:I}Z^{I}, Θᵢ is a set of nodes which can be reached from [i], p_{i:i}Z^{I} is a total probability of starting from [i] to reach nodes of the set I.

Preferably, the universal generation function process unit comprises a multiplication operator [symbol] to apply to the calculation of the universal generation function.

Preferably, R_{J}=Σ_{I}π_{i:I}, π_{i:I} is a probability of starting from [i] and unable to reach any node of the set I via a sub-network of the network.

### BRIEF DESCRIPTION OF THE DRAWINGS

Hereinafter, embodiments of the present invention will be described in detail with reference to the accompanying drawings so that those skilled in the art to which the present invention pertains can realize the present invention, wherein:

FIG. 1 is a block diagram of an evaluation system of multi-state information network according to an embodiment of the present application;

FIG. 2 is a schematic view of an evaluation system of multi-state information network according to another embodiment of the present application; and

FIG. 3 is a flow chart of an evaluation method of multi-state information network according to the second embodiment of the present application.

### DETAILED DESCRIPTION OF THE PREFERRED EMBODIMENTS

As used herein, the term “and/or” includes any and all combinations of one or more of the associated listed items. Expressions such as “at least one of,” when preceding a list of elements, modify the entire list of elements and do not modify the individual elements of the list.

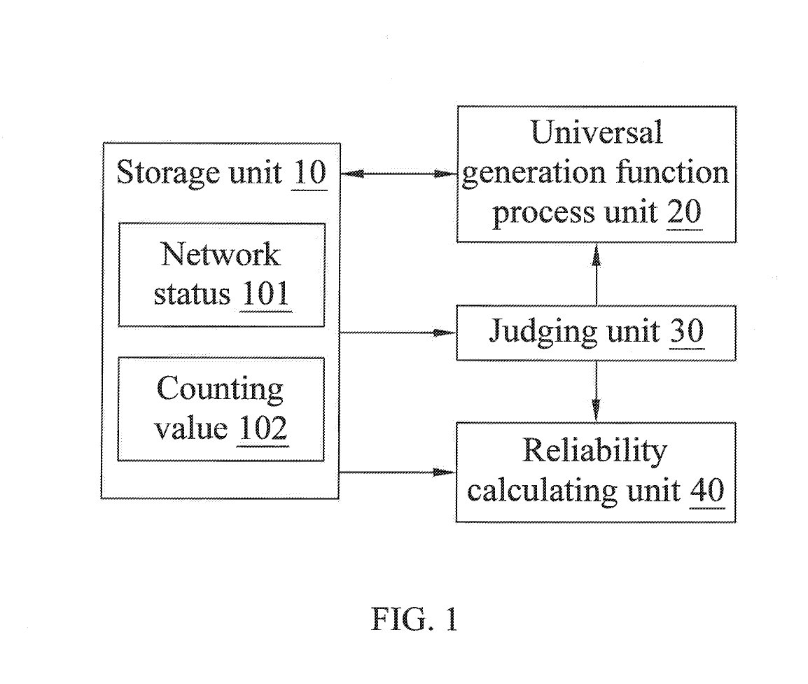

Referring to FIG. 1, FIG. 1 is a block diagram of an evaluation system for multi-state information network according to an embodiment of the present application. As shown in FIG. 1, the reliability evaluation system of multi-state information network comprises a storage unit 10, a universal generation function process unit 20, a judging unit 30, and a reliability calculating unit 40. A network status 101 and a counting value 102 are stored in the storage unit 10, and the counting value 102 is set as 1 initially. The multi-state information network is composed of a plurality of nodes and a plurality of arcs, and the plurality of nodes comprises a starting node and at least one target node. The information is transmitted from the starting node to at least one target node via a plurality of arcs. The evaluation system comprises a computer host, a server, a workstation, or a notebook. The storage unit 10 comprises a memory, a tap, or a hard-disk. The universal generation function process unit 20, the judging unit 30, and the reliability calculating unit 40 may be implemented by an application program.

In detail, based on the network status 101, the counting value 102, a node v, and the universal generation function of the (i−1) stage sub-network Ur([i−1]), the universal generation function of the i-stage u([i]) and the universal generation function of the i stage sub-network U([i]) are calculated by the universal generation function process unit 20 first. After the universal generation function of the i stage sub-network is simplified, the simplified universal generation of the i stage sub-network is stored into the storage unit 10. At the same time, the counting value 102 is equal to 1 and the node v is set as the starting node.

Based on the network status 101, the universal generation function of the i stage sub-network U([i]) and a set J, the reliability calculating unit 40 obtains a reliability coefficient R_{J}. With the reliability coefficient R_{J}, the reliability of the multi-state information network is calculated. The set J is contained in a set including at least a target node. In other words, the set J comprises {(2), (3), (5), (2, 3), (2, 5), (3, 5), (2, 3, 5)} when the at least one target node comprises the node 2, the node 3, and the node 5. The reliability coefficient R_{J} is the total probability of all target nodes not in J receiving information from the starting node of the i stage sub-network U([i]). For example, it is assumed that the node {2} is the starting node, the target node comprises the node {5}, and the set of nodes which can be reached from node {2} comprises the node {3}, the node {5} and the node {3, 5}, and then the reliability coefficient generated by the node {2} comprises π_{2:{φ}}, π_{2:{3}}, π_{2:{3, 5}}, and π_{2:{5}}. The R_{J} is equal to the sum of π_{2:{φ}} and π_{2:{3}}. The π_{2:{φ}} represents the reliability coefficient from the node {2} to the node {2} and the π_{2:{3}} represents the reliability coefficient from the node {2} to the node {3}.

When the judging unit 30 judges that the counting value 102 is less than a threshold value, the counting value 102 is incremented by 1, the universal generation function process unit 20 is enabled to continue the reliability evaluation process, and the reliability calculating unit 40 is enabled to continue the calculation. On the other hand, the reliability evaluation process is terminated if the counting value 102 is higher than the threshold value, where the threshold value represents the number of the plurality of nodes excluding all targets nodes. For example, when the number of all nodes is equal to ten and the target nodes comprise three nodes, the threshold value is equal to seven. Furthermore, after the counter value is set as 2 (including 2), a new node v is chosen from the nodes which are connected to V_{[i-1]} and not belong to any node of V_{[i-1]}, where V_{[i-1]}={[1], [2], . . . [i−1]}.

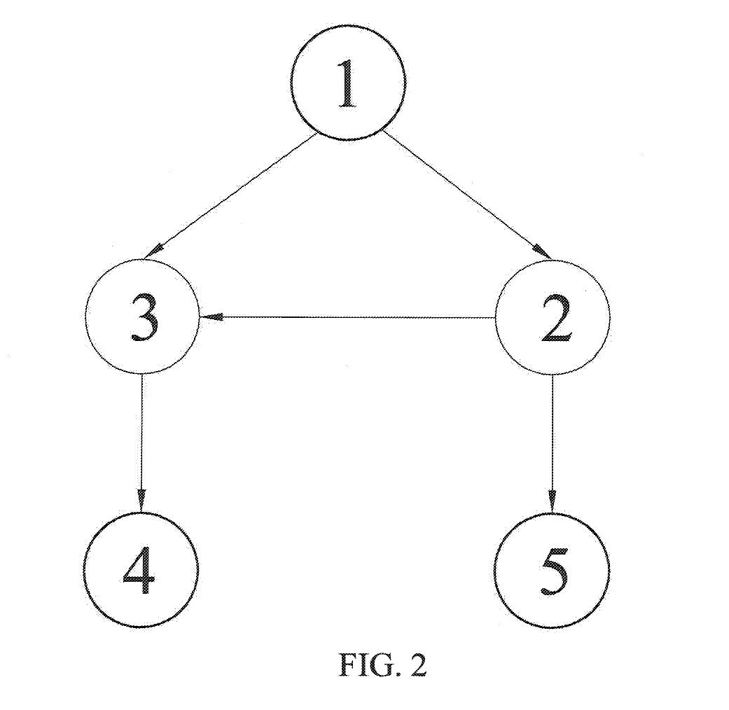

Referring to FIG. 2, FIG. 2 is a schematic view of an evaluation system of multi-state information network according to another embodiment of the present application. As shown in FIG. 2, the node {1} is a starting node in the multi-state information network, and the node {4} and the node {5} are the targets node in the multi-state information network. The arrow of the arc in FIG. 2 displays the direction of the information flow. The reliability of the multi-state information network is the reliability calculated from the node {1} to the node {4} or the node {5}. First, the counting value (i) is set as 1 and the node v is set as the node {1}. The judging unit 30 sets the counting value (i) as 2, and enables the universal generation function process unit 20 and the reliability calculating unit 40 to do the further calculation.

Preferably, when the counting value (i) is equal to 2, π_{1:{φ}}=p_{1:{φ}}, π_{1:{2}}=p_{1:{2}}, π_{1:{3}}=p_{1:{3}, π}_{1:{2:3}}=p_{1:{2:3}}, U([1])=u([1])=π_{1:{φ}Z}^{φ}+π_{1:{2}}Z²+π_{1:{3}}Z³+π_{1:{2, 3}}Z^{{2, 3}}, u([2])=p_{2: φ}Z^{φ}+p_{2:{3}}Z^{{3}}+p_{2:{5}}Z^{{5}}+p_{2:{3, 5}}Z^{{3, 5}}, p_{m:n}Zⁿ represents the probability transmitting the information from the node in to a set n. π_{v:J} represents the coefficient Z^{J} in the sub-network of the universal generation function from the existing universal generation function method and U([i])=Σ_{I∈θ}_{ᵢ} P_{i:I}Z^{I}, Θᵢ represents a set of nodes that can be reached from the node {i}, p_{i:I}Z^{I} represents a total probability of starting from the node {i} to reach nodes in the set I, u{[i]} represents the i stage universal generation function, and U([i]) represents the universal generation function of the i stage sub-network.

Further, the U([2]) is computed as: U([2])=U([1]) [symbol] u([2])=(π_{1:{φ}}Z^{φ}+π_{1:{2}}Z²+π_{1:{3}}Z³+π_{1:{2, 3}}Z^{{2, 3}}) [symbol] [p_{2: φ} ^{Z}^{φ}+p_{2:{3}}Z^{{3}}+p_{2:{5}}Z^{{5}}+p_{2:{3,5}}Z^{{3,5}}]=π_{1:{φ}}Z^{φ}+π_{1:{3}}Z³+(π_{1:{2}}Z²+π_{1:{2, 3}}Z^{{2, 3}}) [symbol] [p_{2:φ} Z^{φ}+p_{2:{3}}Z^{{3}}+p_{2:{5}}Z^{{5}}+p_{2:{3, 5}}Z^{{3, 5}}]. And the [symbol] is a multiplying operator of the universal generation function.

Preferably, the U([2]) can be simplified as U([2])=π_{2:{φ}}Z^{φ}+π_{2:{3}}Z³+π_{2:{5}}Z⁵+π_{2:{3, 5}}Z^{{3, 5}}, π_{2:{φ}}=p_{1:φ}+p_{1:{2}}p_{2:φ}, π_{2:{3}}=p_{1:3}+p_{1:{2}}P_{2:{3}}+p_{1:{2, 3}}P_{2:φ}+p_{1:{2, 3}}p_{2:{3}}, π_{2:{3 5}}=p_{1:{2}}p_{2:{3, 5}}+p_{1:{2, 3}}p_{2:{5}}+p_{1:{2, 3}}p_{2:{3, 5}}, π_{2:{5}}=p_{1:{2}}p_{2:{5}.}

At the moment, R₅=π_{2:{φ}}+π_{2:{3}}=p_{1:φ}+p_{1:{2}}p_{2:φ}+p_{1:3}+p_{1:{2}}p_{2:{3}}+p_{1:{2, 3}}p_{2:φ}+p_{1:{2, 3}}p_{2:{3}}, and R₅=Σ_{I}π_{i:I}, i=2, I=5, π_{i:I} represents a total probability of starting from the node [I] to reach the set I via a sub-network of the multi-state information network. That is, the non-reliability of the sub-network is evaluated by the disconnectedness feature.

The counting value is changed to 3 by incrementing 1. The u(3)=p_{3: φ} Z^{φ}+p_{3:{4}}Z^{{4}}, U(3)=U2 [symbol] u(3)=(π_{2:{φ}}Z^{φ}+π_{2:{3}}Z³+π_{2:{5}}Z⁵+π_{2:{3, 5}}Z^{{3, 5}}) [symbol] (p_{3: φ} Z^{φ}+p_{3:{4}}Z^{{4}}). U(3) can be simplified as : U(3)=π_{3:φ}Z^{φ}+π_{3:{4}}Z⁴+π_{3:{5}}Z⁵+π_{3:{4, 5}}Z^{{4, 5}}, π_{3:φ}=π_{2:{φ}}+π_{2:{3}}p_{3:φ}, π_{3:{4}}=π_{2:{3}}p_{3:{4}}, π_{3:{5}}=π_{2:{5}}+π_{2:{3, 5}}p_{3:φ}, π_{3:{4, 5}}=π_{2:{3, 5}}p_{3:{4}}.

R_{{4}} and R_{{5}} can be computed as: R_{{4}}=π_{3:{φ}}+π_{3:{5}}=π_{2:{φ}}+π_{2:{3}}p_{3:φ}+π_{2:{5}}+π_{2:{3,5}}p_{3:φ}=(p_{1:φ}+p_{1:{2}}p_{2:φ})+(p_{1:3}+p_{1:{2}}p_{2:{3}}+p_{1:{2,3}}p_{2:φ}+p_{1:{2,3}}p_{2:{3}})p_{3:φ}+p_{1:{2}}p_{2:{5}}Z⁵+(p_{1:3}+p_{1:{2}}p_{2:{3}}+p_{1:{2,3}}p_{2:φ}+p_{1:{2, 3}}p_{2:{3}})p_{3:φ}, R_{{4,5}}=π_{3:φ}+π_{3:{4}}+π_{3:{5}}=π_{2:φ}+π_{2:{3}}p_{3:φ}+π_{2:{3}}p_{3:4}+π_{2:5}+π_{2:{3,5}}p_{3:φ}=(p_{1:φ}+p_{1:{2}}p_{2:φ})+(p_{1:3}+p_{1:{2}}p_{2:{3}}+p_{1:{2, 3}}p_{2:φ}+p_{1:{2, 3}}p_{2:{3}})p_{3:φ}+(p_{1:3}+p_{1:{2}}p_{2:{3}}+p_{1:{2, 3}}p_{2:φ}+p_{1:{2, 3}}p_{2:{3}}) p_{3:4}+p_{1:{2}}p_{2:{5}}Z⁵+(p_{1:{2}}p_{2:{3, 5}}+p_{1:{2, 3}}p_{2:{5}}+p_{1:{2, 3}}p_{2:{3, 5}})p_{3:φ}.

The threshold value is 3(3−5−2) since two of five nodes are target nodes in FIG. 2. And, the calculation of the reliability is terminated because the counting value is incremented to 3. After R_{{4}}, R_{{5}} and R_{{4, 5}} are obtained, each of them represents the probability of starting from the node {1} but unable to reach the node {4}, the probability of starting from the node {1} but unable to reach the node {5}, and the probability of starting from the node {1} but unable to reach the node {4} or the node {5}, that is, the non-reliability of the network is obtained. Therefore, the probability of reaching the node {4}, the node {5}, and the node {4} or the node {5} can be evaluated as 1−R_{{4}}, 1−R_{{5}}, and 1−R_{{4, 5}}, that is, the reliability of the network is obtained.

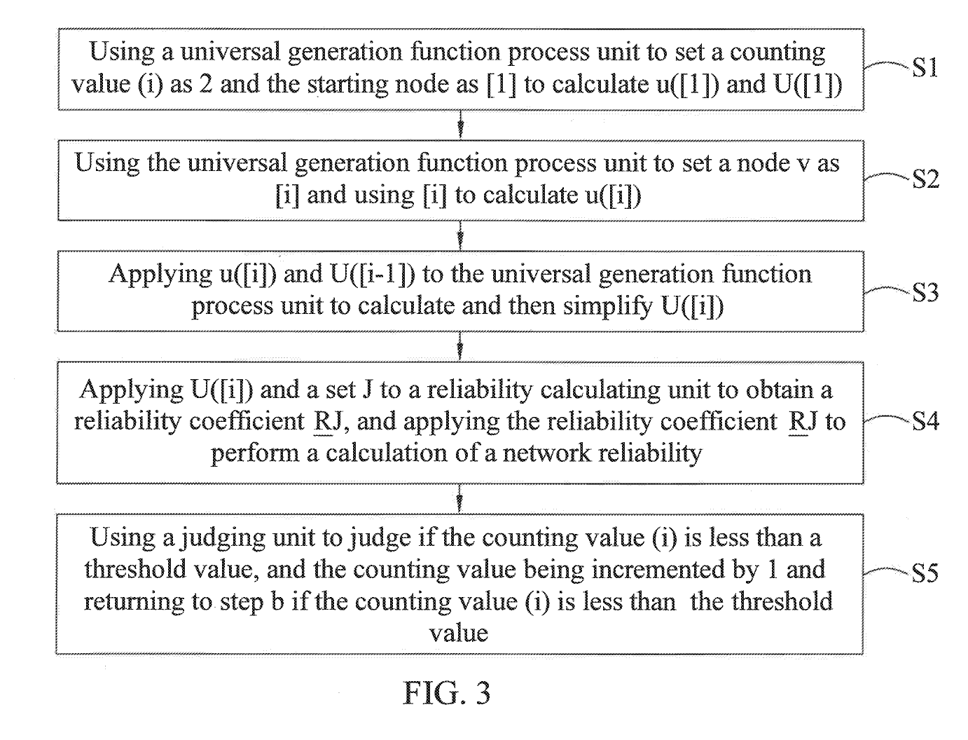

Referring to FIG. 3, FIG. 3 is a flow chart of an evaluation method of multi-state information network according to the second embodiment of the present application. As shown in FIG. 3, the evaluation method is applied for a network which comprises a plurality of nodes and a plurality of arcs connected with the plurality of nodes. Each of nodes comprises a starting node and at least one target node. In step S1, a universal generation function process unit is used to set a counting value (i) as 2 and the starting node as [1] to calculate u([1]) and U([1]). The first-stage node is represented by [1], the universal generation function of the first-stage node is represented by u([1]), the universal generation function of the first-stage sub-network is represented by U([1]), and U([1])=u([1]). In step S2, the universal generation function process unit is used to set a node v as [i], and [i] is used for calculating u([i]). The i-stage node is represented by [i], the i-stage node universal generation function is represented by u([i]), the node v is connected to V_{[i-1]} and the node v does not belong to V_{[i]}, and V_{[i-1]}={[1], [2], . . . , [i−1]}. In step S3, u([i]) and U([i−1]) are applied to calculate and simplify U([i]). The i−1 stage and the i stage universal generation functions are represented by U([i−1]) and U([i]), respectively. In step S4, U([i]) and a set J are applied to obtain a reliability coefficient R_{J} by a reliability calculating unit, and the reliability coefficient R_{J} is applied to perform a calculation of a network reliability. The set J is contained in a set including at least a target node, and the reliability coefficient R_{J} is the probability of all target nodes not in J receiving information from the starting node in U([i]). In step S5, a judging unit is used to judge that the counting value (i) will be incremented by 1 and step S2 will be performed if the counting value (i) is less than a threshold value. The threshold value is equal to the number of nodes of the plurality of nodes excluding at least one of the target nodes.

The aforementioned preferred embodiment is to explain the technical ideas and features of the present application. The purpose is to enable those who skilled in this technical area to understand the content of the present application and realize it. It will be understood that the present application is not limited to the details thereof. Various equivalent variations and modifications may still occur to those skilled in this art in view of the teachings of the present application. Thus, all such variations and equivalent modifications are also embraced with the scope of the present application as defined in the appended claim.

What is claimed is:

1. A reliability of a multi-state information network evaluation method applicable to a network, the network comprising a plurality of nodes and a plurality of arcs to connect the plurality of nodes, the plurality of nodes at least comprising a starting node and a target node, and the evaluation method comprising the following steps:
a. using a universal generation function process unit to set a counting value (i) as 2 and the starting node as [1] to calculate u([1]) and U([1]), wherein [1] represents the first-stage node, u([1]) represents the universal generation function of the first-stage node, U([1]) represent the universal generation function of the first-stage sub-network, and U([1])=u([1]);
b. using the universal generation function process unit to set a node v as [i] and using [i] to calculate u([i]), wherein [i] represents the i-stage node, u([i]) represents the i-stage node universal generation function, the node v is connected to V_{[i-}1] and the node v does not belong to V_{[i-}1], and V_{[i-1]}={[1], [2], . . . , [i−1]};
c. applying u([i]) and U([i−1]) to the universal generation function process unit to calculate and then simplify U([i]), wherein U([i−1]) and U([i]) represent the i−1 stage and the i stage universal generation functions, respectively;
d. applying U([i]) and a set J to a reliability calculating unit to obtain a reliability coefficient R_{J}, and applying the reliability coefficient R_{J} to perform a calculation of a network reliability, wherein the set J is contained in a set including at least a target node, and the reliability coefficient R_{J} is the probability of all target nodes not in J receiving information from the starting node in U([i]); and
e. using a judging unit to judge if the counting value (i) is less than a threshold value, and the counting value being incremented by 1 and returning to step b if the counting value (i) is less than the threshold value.

2. The reliability of a multi-state information network evaluation method of claim 1, wherein the threshold value is equal to the number of nodes of the plurality of nodes excluding at least one of the target nodes.

3. The reliability of a multi-state information network evaluation method of claim 1, wherein u([i])=Σ_{I∈θ}_{ᵢ} p_{i:I}Z^{I}, Θᵢ is a set of nodes which can be reached from [i], p_{i:I}Z^{I} is a total probability of starting from [i] to reach nodes of the set I.

4. The reliability of a multi-state information network evaluation method of claim 1, wherein R_{J}=Σ_{I}π_{i:I}, π_{i:I} is a probability of starting from [i] and unable to reach any node of the set I via a sub-network of the network.

5. The reliability of a multi-state information network evaluation method of claim 1, wherein the universal generation function process unit comprises a multiplication operator [symbol] to apply to the calculation of the universal generation function.

6. A reliability of a multi-state information network evaluation system applicable to a network, the network comprising a plurality of nodes and a plurality of arcs to connect the plurality of nodes, the plurality of nodes at least comprising a starting node and a target node, and the evaluation system comprising:
a storage unit, adapted to save a counting value (i) and a network status of the network, wherein the counting value (1) is set as 1 initially;
a universal generation function process unit, adapted to calculate u([i]) and U([i]) via applying the network status, the counting value (i), a node v, and U([i−1]), and simplify U(i) before storing U(i) into the storage unit, wherein i is a positive integer, [i] represents the i-stage node, U(i) represents universal generation function of the i-stage sub-network, and u([i]) represents universal generation function of the i-stage node;
a reliability calculating unit, adapted to obtain a reliability coefficient R_{J} via applying the network status, U(i) and a set J, and apply the coefficient R_{J} to perform a calculation. of a network reliability, wherein the set J is contained in a set including at least a target node, and the reliability coefficient R_{J} is the probability of all target nodes not in J receiving information from the starting node in U([i]); and
a judging unit, adapted to judge if the counting value (i) is less than a threshold value, the counting value (i) being incremented by 1, the universal generation function process unit is enabled to continue the process, and the reliability calculating unit is enabled to continue the calculation;
wherein the node v is the starting node if the counting value (i) is equal to 1; the node v is connected to V[i−1] and v is not belong to any node of V[i−1] if the counting value (i) is not equal to 1.

7. The reliability of a multi-state information network evaluation system of claim 6, wherein the threshold value is equal to the number of nodes of the plurality of nodes excluding at least one of the target nodes.

8. The reliability of a multi-state information network evaluation system of claim 6, wherein u([i])=Σ_{I∈θ}_{ᵢ} p_{i:I}Z^{I}, Θᵢ is a set of nodes which can be reached from [i], p_{i:I}Z^{I} is a total probability of starting from [i] to reach nodes of the set I.

9. The reliability of a multi-state information network evaluation system of claim 6, wherein the universal generation function process unit comprises a multiplication operator [symbol] to apply to the calculation of the universal generation function.

10. The reliability of a multi-state information network evaluation system of claim 6, wherein R_{J}=Σ_{I}π_{i:I}, π_{i:I} is a probability of starting from [i] and unable to reach any node of the set I via a sub-network of the network.
